(19) United States
(12) Patent Application Publication
(10) Pub. No.: US 2011/0238909 A1
(43) Pub. Date: Sep. 29, 2011

(54) Multicasting Write Requests To Multiple Storage Controllers

(76) Inventors: Pankaj Kumar, Chandler, AZ (US); James A. Mitchell, Chandler, AZ (US)

(21) Appl. No.: 12/748,764

(22) Filed: Mar. 29, 2010

(51) Int. Cl. G06F 12/16; G06F 17/30

(52) U.S. Cl. 711/114; 707/656; 707/E17.005; 711/E12.103

(57) ABSTRACT

In one embodiment, the present invention includes a method for performing multicasting, including receiving a write request including write data and an address from a first server in a first canister, determining if the address is within a multicast region of a first system memory, and if so, sending the write request directly to the multicast region to store the write data and also to a mirror port of a second canister coupled to the first canister to mirror the write data to a second system memory of the second canister. Other embodiments are described and claimed.

### BACKGROUND

Storage systems such as data storage systems typically include an external storage platform having redundant storage controllers, often referred to as canisters, redundant power supply, cooling solution, and an array of disks. The platform solution is designed to tolerate a single point failure with fully redundant input/output (I/O) paths and redundant controllers to keep data accessible. Both redundant canisters in an enclosure are connected through a passive backplane to enable a cache mirroring feature. When one canister fails, the other canister obtains the access to hard disks associated with the failing canister and continues to perform I/O tasks to the disks until the failed canister is serviced.

To enable redundant operation, system cache mirroring is performed between the canisters for all outstanding disk-bound I/O transactions. The mirroring operation primarily includes synchronizing the system caches of the canisters. While a single node failure may lose the contents of its local cache, a second copy is still retained in the cache of the redundant node. However, certain complexities exist in current systems, including the limitation of bandwidth consumed by the mirror operations and the latency required to perform such operations.

### BRIEF DESCRIPTION OF THE DRAWINGS

FIG. 1 is a block diagram of a system in accordance with an embodiment of the present invention.

FIG. 2 is a block diagram showing details of canisters in accordance with another embodiment of the present invention.

FIG. 3 is a data flow of operations in accordance with an embodiment of the present invention.

FIG. 4 is a block diagram of components used in direct address translation in accordance with an embodiment of the present invention.

### DETAILED DESCRIPTION

In various embodiments, incoming write operations to a storage canister may be multicasted to multiple destination locations. In one embodiment these multiple locations include system memory associated with the storage canister and a mirror port, e.g., corresponding to another storage canister. In this way, the need for various read/write operations from system memory to the mirror port can be avoided.

While the scope of the present invention is not limited in this regard, multicasting, which may be a dualcast to two entities or a multicast to more than two entities, may be performed in accordance with a Peripheral Component Interconnect Express (PCI Express™ (PCIe™)) dual-casting feature in accordance with an Engineering Change Notice to the PCIe™ Base Specification, Version 2.0 (published Jan. 17, 2007). Here, assume a first canister receives an inbound posted write request, e.g., from a host. Based on an address of the request, the write request packet may be directed to two destinations, namely system memory of the first canister and the mirroring port, e.g., a second canister coupled to the first canister, e.g., via a PCIe™ non-transparent bridge (NTB) port. In one embodiment, the incoming address may be compared to base address register (BAR) and limit registers of the first canister (e.g., associated with the PCIe™ I/O port of the first canister) and the mirroring port (PCIe™ NTB) to ensure that the packets are routed to both the system memory and mirroring port. This routing can be performed concurrently, rather than a serial implementation in which data must first be written to the system memory and then mirrored over to the second canister.

Using embodiments of the present invention, streaming mirror write data flows for a redundant array of inexpensive disks (RAID) system such as a RAID 5/6 system can be improved. Because storage workloads in such a system can be highly I/O intensive and touch system memory multiple times, a significant amount of system memory bandwidth may be consumed, particularly in entry-to-mid-range platforms which can be performance-limited by system memory. Using a storage acceleration technology in accordance with an embodiment of the present invention, memory bandwidth can be reduced. In this way, lower performance system memory can be adopted within a system, reducing system cost. For example, bin-1 memory components (having a lower rated frequency than a high bin component) or low-cost dual inline memory modules (DIMMs) can be used to obtain higher RAID-5/6 performance.

While embodiments may use a PCIe™ dualcast operation to perform an inbound write request from I/O write to system memory and PCIe™-to-PCIe™ NTB as a single operation, other implementations can use a similar multicast or broadcast operation to concurrently direct a write operation to multiple destinations.

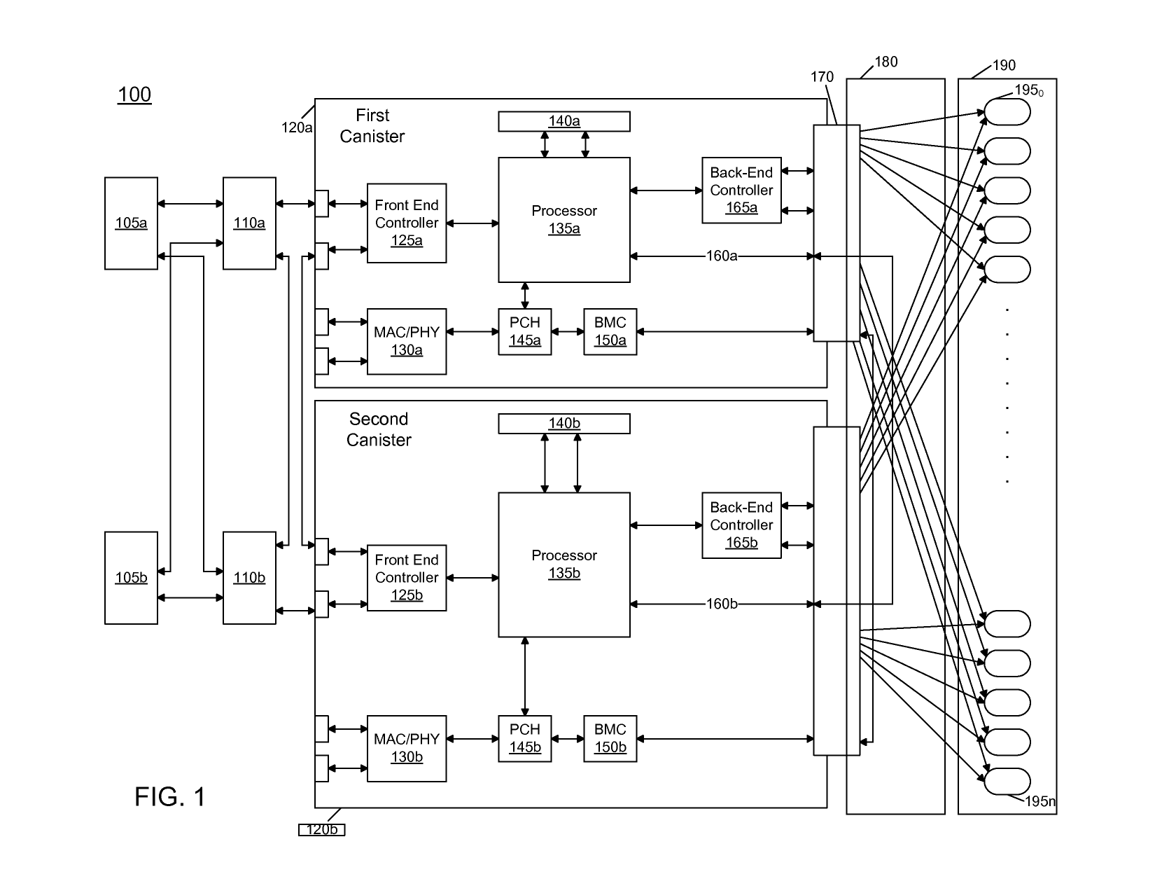

Referring now to FIG. 1, shown is a block diagram of a system in accordance with an embodiment of the present invention. As shown in FIG. 1, system 100 may be a storage system in which multiple servers, e.g., servers 105ₐ and 105_{b} (generally servers 105) are connected to a mass storage system 190, which may include a plurality of disk drives 195₀-195ₙ (generally disk drives 195), which may be a RAID system and may be according to a Fibre Channel/SAS/SATA model. In RAID-5 or RAID-6 configurations, one disk and two disk failures, respectively can be tolerated on a storage platform.

To realize communication between servers 105 and storage system 190, communications may flow through switches 110ₐ and 110_{b} (generally switches 110), which may be gigabit Ethernet (GigE)/Fibre Channel/SAS switches. In turn, these switches may communicate with a pair of canisters 120ₐ and 120_{b} (generally canisters 120). Each of these canisters may include various components to enable cache mirroring in accordance with an embodiment of the present invention.

Specifically, each canister may include a processor 135 (generally). For purposes of illustration first canister 120ₐ will be discussed and thus processor 135ₐ may be in communication with a front-end controller device 125ₐ. In turn, processor 135ₐ may be in communication with a peripheral controller hub (PCH) 145ₐ that in turn may communicate with peripheral devices. Also, PCH 145 may be in communication with a media access controller/physical device (MAC/PHY) 130ₐ which in one embodiment may be a dual GigE MAC/PHY device to enable communication of, e.g., management information. Note that processor 135ₐ may further be coupled to a baseboard management controller (BMC) 150ₐ that in turn may communicate with a mid-plane 180 via a system management (SM) bus.

Processor 135ₐ is further coupled to a memory 140ₐ, which in one embodiment may be a dynamic random access memory (DRAM) implemented as dual in-line memory modules (DIMMs). In turn, the processor may be coupled to a back-end controller device 165ₐ that also couples to mid-plane 180 through mid-plane connector 170.

Furthermore, to enable mirroring in accordance with an embodiment of the present invention, a PCIe™ NTB interconnect 160 may be coupled between processor 135ₐ and mid-plane connector 170. As seen, a similar interconnect may directly route communications from this link to a similar PCIe™ NTB interconnect 160_{b} that couples to processor 140_{b} of second canister 120_{b}. This interconnection between processors via the NTB interconnect may form an NTB address domain. Note that in some implementations, the canisters may directly couple without a mid-plane connector. In other embodiments, instead of a PCIe™ interconnect, another point-to-point (PtP) interconnect such as in accordance with the Intel® Quick Path Interconnect (QPI) protocol may be present. As seen in FIG. 1, to enable redundant operation mid-plane 180 may enable communication from each canister to each corresponding disk drive 195. While shown with this particular implementation in the embodiment of FIG. 1, the scope of the present invention is not limited in this regard. For example, more or fewer servers and disk drives may be present, and in some embodiments additional canisters may also be provided.

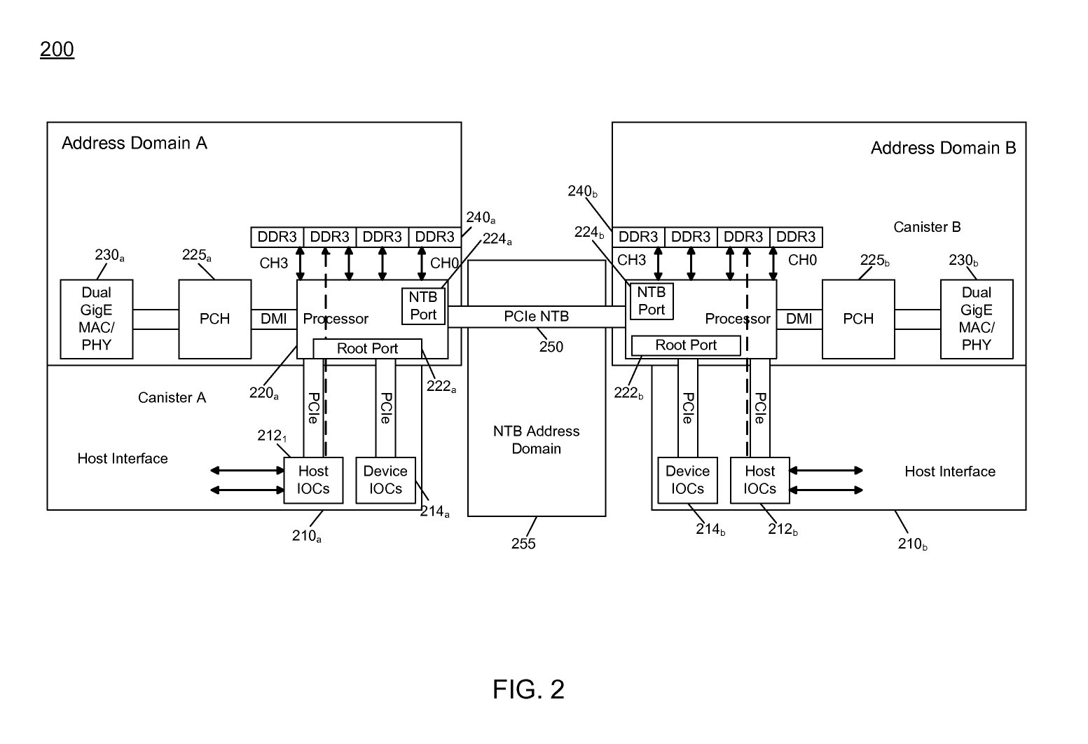

Referring now to FIG. 2, shown is a block diagram showing details of canisters in accordance with another embodiment of the present invention. Note that the canisters of FIG. 2, namely a first canister 210ₐ and a second canister 210_{b} may be part of a system 200 including one or more servers, a storage system such as a RAID system and peripherals and other such devices. However, in at least some implementations the need for a switch to couple a server to the canisters can be avoided. First canister 210ₐ and second canister 210_{b} are coupled via a PCIe™ NTB link 250, although other PtP connections are possible. Via this link, system cache mirroring between the two canisters can occur. A NTB address domain 255 is accessible by both canisters 210. In the implementation shown, each canister 210 may have its own address domain and may include a system memory 240 which in one embodiment may be implemented using low-cost DIMMs enabled by the storage acceleration available using techniques in accordance with an embodiment of the present invention.

As seen in FIG. 2, each canister may include I/O controllers, including one or more host I/O controllers 212 to enable communication with servers and other host devices, and one or more device I/O controllers 214 to enable communication with the disk system. As seen, such I/O controllers may communicate with a corresponding processor 220 via a root port 222. In turn, each processor may further include an NTB port 224 to enable communications via NTB interconnect 250, which may be of NTB address domain 255. Processor 220 may further communicate with a PCH 225 which in turn may in communication with a MAC/PHY 230. Note that processor 220 may include various internal components, including an integrated memory controller to enable communications with system memory, as well as an integrated direct memory access (DMA) engine, and a RAID processor unit, among other such specialized components.

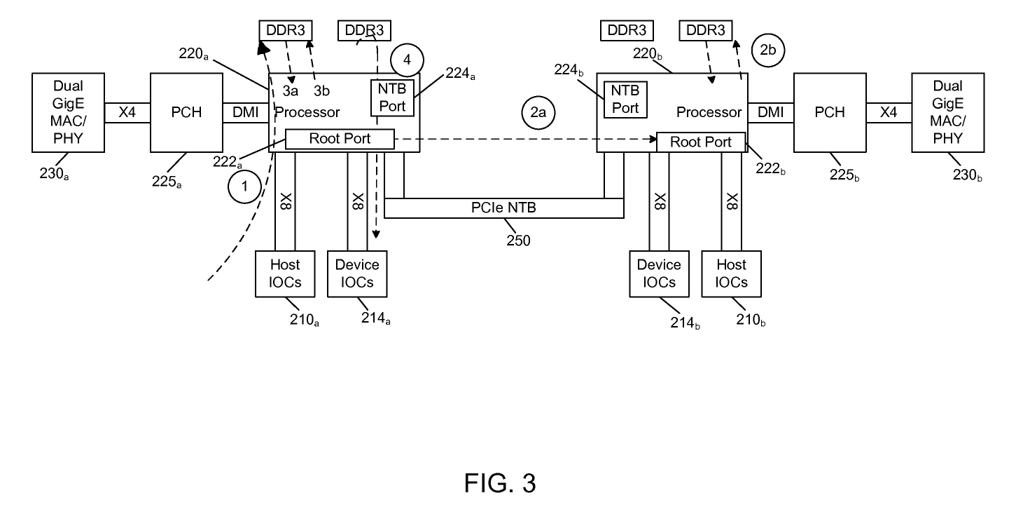

Using storage acceleration in accordance with an embodiment of the present invention, a dualcasting technique may be used to communicate write data of a write request directly to system memory as well as to a connected device, e.g., a PCIe™-connected device such as another canister. Referring now to FIG. 3, shown is a data flow of operations in accordance with an embodiment of the present invention. As shown in FIG. 3, the data flow for a RAID-5/6 streaming mirror write is set forth. In general, a data flow to receive a write request and perform dualcasting mirroring may include two memory read operations and 2.25 write operations. As seen, an incoming write request from, e.g., a server may be received via a host I/O controller 212ₐ of first canister 210ₐ. Depending on the address of the write request, a dualcast operation may be initiated. Specifically, as will be discussed below if the address is within a dualcast region of memory, the host controller may concurrently directly write the data to system memory 240ₐ as well as mirror the data to canister 210_{b} via the NTB interconnect. In turn, the processor of the second canister will write the data to its system memory as a mirror write operation.

As of this time the write data may be present in both system memories. Then, in one implementation a RAID processor unit, e.g., of processor 220ₐ or a dedicated RAID processor of canister 210ₐ may read the data from memory and perform RAID-5/6 parity computations and write the parity data to the system memory 240ₐ, e.g., in association with the write data. Finally, a device I/O controller 214ₐ may read both the write data and the RAID parity data from the corresponding system memory 240ₐ and write the data to disk, e.g., according to a RAID-5/6 operation in which the data may be striped across multiple disks.

Note that various acknowledgements may occur during the processing described above. For example, when the mirrored write data is successfully received in the protected domain of canister 210_{b} to be written to system memory 240_{b}, canister 210_{b} may communicate an acknowledgement back to first canister 210ₐ. As this acknowledgment indicates that the write data has now been successfully written to both system caches, namely the two system memories, at this time first canister 210ₐ may send an acknowledgement back to the requestor, e.g., a server to acknowledge successful completion of the write request. Note that this acknowledgement may be sent before the write data is written to its final destination in the RAID system, due to the redundancy provided by the dual system caches. Accordingly, the write from system memory 240ₐ to disk can occur in the background. Note that the system memories of the two canisters are backed up by battery backup. In addition, upon writing the data to the drive system, first canister 210ₐ may communicate a message to second canister 210_{b} to indicate successful writing. At this time, the write data stored in system memory 240_{b} (and system memory 240ₐ) may be set to a dirty state so that the space can be re-used for other data.

Thus the need to first write inbound data from a host I/O controller to system memory and then use a DMA engine (e.g., of the processor) to mirror the data between the two canisters can be avoided. Instead, using an embodiment of the present invention the inbound I/O write packet can be sent concurrently to two destinations, system memory and the mirror port, eliminating memory read/write operations and saving memory bandwidth to offer higher performance. Or lower cost memory (e.g., bin frequency-1) can be used to offer performance comparable to conventional RAID streaming operations. While described with this particular implementation in the embodiment of FIG. 3, the scope of the present invention is not limited in this regard.

To multicast a transaction originating at an upstream port of a root port that is to target both system memory and a peer device, a mechanism may be used to allow transactions that target a subset of system memory also to be copied transparently to the mirror port (e.g., the PCIe™ NTB port). To this end, software may create in each root port a multicast memory window capable of multicast operations. As one example, a base and limit register may be provided to mirror the size of one of the NTBs primary BARs, which may correspond to the entire BAR defined during enumeration for the NTB or a subset of that BAR.

When an upstream write transaction is seen on the root port, it is decoded to determine its destination. If the address of the write hits the multicasting memory region, it will be sent to both the system memory without translation and to the memory window of the NTB after translation. In one embodiment, the translation may be a direct address translation between the two sides of the NTB.

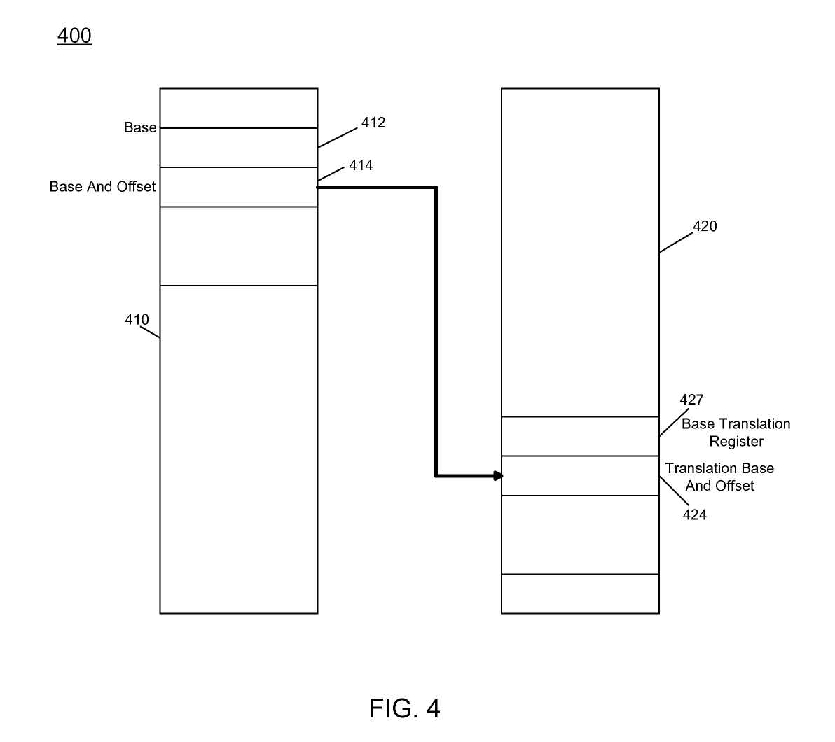

In one embodiment, direct address translation may occur after appropriately setting up local and remote host address maps, which may be located in each respective host's system memory. Referring now to FIG. 4, shown is a block diagram of components used in direct address translation in accordance with an embodiment of the present invention. As shown in FIG. 4, a local host address map 410 and a remote host address map 420 may be present. As seen, local map 410 may include a base location 412 which may correspond to a base address for a dual cast memory region. In addition, a base plus offset location 414 may be used to reach a translated base and offset region 424 of remote map 420. In addition, a base translation register 422 may be present in remote map 420. Various other registers and locations may be present within these address maps.

The following steps outline one possible implementation. For setup, software reads values stored in the NTB for a base address register (e.g., PBAR23SZ) and sets a base address for dualcast operation (DUALCASTBASE) to a size multiple of PBAR23SZ. This means if PBAR23SZ is 8 gigabytes (GB) then DUALCASTBASE is placed on a size multiple of PBAR23SZ, e.g., 8G, 16G, 24G, or so forth. Next, a limit address for dualcast operation may be set. This limit address (DUALCASTLIMIT) may be set less than or equal to DUALCASTBASE+PBAR23SZ (for example if PBAR23SZ=8G and DUALCASTBASE=24G then DUALCASTLIMIT can be placed up to 32G). Accordingly, the dualcast region may be set to represent the region of system memory that the user wishes to mirror into remote memory. These operations may be set by an operating system (OS) in one embodiment.

During operation, an upstream transaction may be checked at the root port to determine if the received address falls within the dualcast memory window created by the OS. This determination may be in accordance with the following equation: Valid Dualcast Address=((DUALCASTLIMIT>Received Address[63:0]>=DUALCASTBASE)).

For example, assume register values of DUALCASTBASE=0000 003A 0000 0000H which is the dualcast base address, placed on a size multiple of PBAR23SZ alignment by the OS, 4 GB in this case, and a DUALCASTLIMIT=0000 003A C000 0000H which reduces the window to 3 GB. Further assume that the Received Address=0000 003A 00A0 0000H. In accordance with the above equation, this corresponds to a valid dualcast address, and thus a translation may occur, discussed further below.

If the received address is outside of this dualcast memory window the transaction can be decoded based upon the requirements of the system. For example, the transaction may be decoded to system memory, peer decode, subtractively decoded to the south bridge, or master aborted.

If as above, the transaction is within the valid dualcast region, it may be translated to the defined primary side NTB memory window. This translation may be as follows:

Translated Address=((Received Address[63:0]&˜Sign_Extend(2̂PBAR23SZ)|PBAR2XLAT[63:0])).

For example, to translate an incoming address claimed by a 4 GB window based at 0000 003A 0000 0000H to a 4 GB window based at 0000 0040 0000 0000H, the following calculation may occur.

Received Address[63:0]=0000003A00A00000H

PBAR23SZ=32, which sets the size of Primary BAR 2/3=4 GB in this example. ˜Sign_Extend(2̂PBAR23SZ)=˜Sign_Extend(0000 0001 0000 0000H)=˜(FFFF FFFF 0000 0000H)=(0000 0000 FFFF FFFFH) PBAR2XLAT=0000 0040 0000 0000H, which is the base address into the NTB primary side memory (size multiple aligned). Accordingly, the Translated Address=0000 003A 00A0 0000H & 0000 0000 FFFF FFFFH|0000 0040 0000 0000H=0000 0040 00A0 0000H.

Note that the offset to the base of the 4 GB window on the incoming address is preserved in the translated address.

Using the translated addresses, a dualcast operation may be performed to send the incoming transaction to system memory at (0000 0030 00A0 0000H) and to the NTB at (0000 0040 00A0 0000H).

Implementations of handling an incoming multicast write request may be performed differently based on the micro-architecture being used. For example, one implementation may be to pop a request off of a receiver posted queue and temporarily hold the transaction in a holding queue. Then, the root port can send independent requests for access to system memory and for access to peer memory. The transaction would remain in the holding queue until a copy has been accepted to both system memory and peer memory and then it is purged from the holding queue. An alternative implementation may wait to pop a request off of the receiver posted queue until both the upstream resources targeting system memory and peer resources are both available and then send to both paths at the same time. For example, the path to main memory can send the request with the same address that was received and the path to the peer NTB can send the request after translation to one of the NTB primary memory windows.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a first canister to control storage of data in a storage system including a plurality of disks, the first canister having a first processor, a first system memory to cache data to be stored in the storage system, and a first mirror port; and
a second canister to control storage of data in the storage system and coupled to the first canister via a point-to-point (PtP) interconnect, the second canister including a second processor, a second system memory to cache data to be stored in the storage system, and a second mirror port, wherein the first and second system memories are to store a mirrored copy of the data stored in the other system memory, wherein the mirrored copy is communicated by dualcast transactions via the PtP interconnect in which incoming data to the first canister is concurrently written to the first system memory and communicated to the second canister through the first and second mirror ports.

2. The apparatus of claim 1, wherein the first canister is directly coupled to a server that originates a write request for the incoming data without a switch.

3. The apparatus of claim 1, further comprising a device controller coupled to the first processor, wherein the device controller is to receive the incoming data from the first system memory and to write the incoming data to at least one drive of a drive system of the storage system.

4. The apparatus of claim 1, further comprising a redundant array of inexpensive disks (RAID) engine of the first processor to read the incoming data from the first system memory and perform a parity operation on the incoming data, and store a result of the parity operation in the first system memory.

5. The apparatus of claim 1, further comprising a root port of the first canister, wherein the root port is to determine whether the incoming data is to be mirrored via a dualcast transaction based on an address of a write request including the incoming data.

6. The apparatus of claim 5, wherein the root port is to translate the address of the write request to a memory window of the second system memory and to send the dualcast transaction to the first system memory with the address and to the second canister with the translated address.

7. The apparatus of claim 2, wherein the second processor is to transmit an acknowledgment upon receipt of the mirrored copy of the incoming data via the PtP interconnect, and responsive to the acknowledgement the first processor is to transmit a second acknowledgment to the server to indicate successful completion of the write request for the incoming data.

8. A method comprising:
receiving a write request including write data and an address from a first server in a first canister of a storage system;
determining if the address is within a multicast region of a system memory of the first canister;
if so, sending the write request directly to the multicast region of the system memory of the first canister to store the write data in the system memory of the first canister and to a mirror port of a second canister coupled to the first canister via a point-to-point (PtP) link to mirror the write data to a system memory of the second canister; and
receiving an acknowledgement of receipt of the write data in the first canister from the second canister via the PtP link, and communicating a second acknowledgement from the first canister to the first server.

9. The method of claim 8, further comprising reading the write data from the system memory of the first canister and performing a parity operation on the write data, and storing a result of the parity operation in the system memory of the first canister.

10. The method of claim 9, further comprising performing the parity operation using a redundant array of inexpensive disks (RAID) engine of a processor of the first canister.

11. The method of claim 10, further comprising thereafter sending the write data and the parity operation result from the system memory of the first canister to a drive system of the storage system via a second interconnect.

12. The method of claim 11, further comprising sending a message from the first canister to the second canister to indicate successful writing of the write data and the parity operation result to the drive system.

13. The method of claim 11, further comprising storing the write data and the parity operation result across a plurality of drives of the drive system.

14. A system comprising:
a first canister including a first processor, a first system memory to cache data, a first input/output (I/O) controller to communicate with a first server, a first device controller to communicate with a disk storage system, and a first mirror port;
a second canister coupled to the first canister via a point-to-point (PtP) interconnect, the second canister including a second processor, a second system memory to cache data, a second I/O controller to communicate with a second server, a second device controller to communicate with the disk storage system, and a second mirror port, wherein the first and second system memories are to store a mirrored copy of the data stored in the other system memory, wherein the mirrored copy is communicated by dualcast transactions via the PtP interconnect in which incoming data of a write request to the first canister is concurrently written to the first system memory and communicated to the second canister through the first and second mirror ports; and
the disk drive system including a plurality of disk drives.

15. The system of claim 14, further comprising a redundant array of inexpensive disks (RAID) engine of the first processor to read the incoming data from the first system memory and perform a parity operation on the incoming data, and store a result of the parity operation in the first system memory.

16. The system of claim 15, wherein the first device controller is to write the incoming data and the parity operation result from the first system memory to at least some of the disk drives of the disk drive system.

17. The system of claim 16, wherein the first canister is to send a message to the second canister to enable the second canister to free a memory region that stores the mirrored copy of the incoming data.

18. The system of claim 14, further comprising a root port of the first canister, wherein the root port is to determine whether the incoming data is to be mirrored via a dualcast transaction based on an address of the write request.

19. The system of claim 18, wherein the root port is to translate the address of the write request to a memory window of the second system memory and to send the dualcast transaction to the first system memory with the address and to the second canister with the translated address.

20. The system of claim 14, wherein the second canister is to transmit an acknowledgment upon receipt of the mirrored copy of the incoming data via the PtP interconnect, and responsive to the acknowledgement the first canister is to transmit a second acknowledgment to the server to indicate successful completion of the write request for the incoming data.
